(19) United States
(12) Patent Application Publication
(10) Pub. No.: US 2007/0021092 A1
(43) Pub. Date: Jan. 25, 2007

(54) Portable computer and control method thereof

(75) Inventor: Seong-geun Park, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/489,548

(22) Filed: Jul. 20, 2006

(30) Foreign Application Priority Data
Jul. 22, 2005 (KR) 2005-66843

(51) Int. Cl. H04B 1/16; H04B 1/38

(52) U.S. Cl. 455/343.1; 455/574

(57) ABSTRACT

A portable computer comprising a digital broadcasting reception module having a digital broadcasting receiving part and a digital broadcasting processor to process digital broadcasting signals received through the digital broadcasting receiving part and a power supply to supply power to drive the digital broadcasting receiving part and the digital broadcasting processor. A controller controls a mode of power supplied to the receiving part and the processing part according to an initialization routine of the portable computer, according to whether an adaptor is supplying the drive power, and according to a user input. The user may set the initialization routine according to whether the user normally desires to use the broadcasting receiving part and may vary the power mode using an input window of the portable computer, to conserve power according to whether the drive power is being operated from an adaptor or from a battery.

### CROSS-REFERENCE TO RELATED APPLICATIONS

This application claims the benefit of Korean Patent Application No. 2005-66843, filed Jul. 22, 2005, in the Korean Intellectual Property Office, the disclosure of which is incorporated herein by reference.

### BACKGROUND OF THE INVENTION

1. Field of the Invention

Aspects of the present invention relate to a portable computer and a control method thereof, and more particularly, to a portable computer which comprises a digital broadcasting reception module and adjusts power consumption according to whether the digital broadcasting reception module is used, and a control method thereof.

2. Description of the Related Art

Digitalized broadcasting has influenced conventional analog radio broadcasting to advance to digital radio broadcasting. Digital multimedia broadcasting (DMB), which transmits data and provides multimedia service, is now available along with the conventional audio radio broadcasting. The digital multimedia broadcasting provides high transmission efficiency and various multimedia services and rarely generates noise in transmission channels or distorts signals.

Accordingly, a digital broadcasting reception module is installed in a mobile phone or a portable computer such as a notebook computer or a personal digital assistant (PDA) to receive digital multimedia broadcasting signals even while the mobile phone or the portable computer is being carried.

A battery is required to use the digital multimedia broadcasting service while the portable computer or the mobile phone (hereinafter, to be referred to as portable computer) is being carried. Further, power consumption by the digital broadcasting reception module should be considered when the portable computer is designed as power saving is a major factor in the portable computer.

Reduction of power consumed by the digital broadcasting reception module according to an operation state thereof would be an advantage when using the portable computer which has the digital broadcasting reception module therein.

### SUMMARY OF THE INVENTION

Accordingly, an aspect of the present invention is to provide a portable computer which adjusts power consumption according to whether a digital broadcasting reception module is used, and a control method thereof.

The foregoing and/or other aspects of the present invention are also achieved by providing a portable computer, comprising a digital broadcasting reception module having a digital broadcasting receiving part to receive digital broadcasting signals and a digital broadcasting processor to process the digital broadcasting signals received through the digital broadcasting receiving part; a power supply to supply power to drive the digital broadcasting receiving part and the digital broadcasting processor; and a system to control the digital broadcasting signal reception module to operate in one of a first power mode in which power supplied from the power supply to the digital broadcasting receiving part and the digital broadcasting signal processor is cut off, a second power mode in which power supplied from the power supply to the digital broadcasting receiving part is cut off, and a third power mode in which power is supplied from the power supply to the digital broadcasting receiving part and the digital broadcasting processor.

According to an aspect of the present invention, the system comprises a power switch which switches power supplied from the power supply to the digital broadcasting receiving part and/or the digital broadcasting processor, and a power manager which controls the power switch to make the digital broadcasting reception module operate in one of the first power mode, the second power mode and the third power mode.

According to an aspect of the present invention, the power manager comprises an initializing routine performer which performs an initial routine to the portable computer and sets whether the digital broadcasting reception module operates in the first power mode while the initial routine is performed.

According to an aspect of the present invention, the power supply receives power from a battery or an adaptor and supplies power to drive the digital broadcasting reception module, and the power manager comprises a power controller which controls the power switch to convert the mode of the digital broadcasting reception module from the first power mode to the second power mode if detected that the power supply receives power from the adaptor.

According to an aspect of the present invention, the portable computer further comprises a mode selection part which selects whether the mode of the digital broadcasting reception module is converted into the third power mode, and the power controller controls the power switch to make the digital broadcasting reception module convert its mode from the second power mode to the third power mode if the conversion to the third power mode is selected through the mode selection part.

According to an aspect of the present invention, the portable computer further comprises a display part to display an image thereon, wherein the power manager further comprises a reception module driver which controls driving of the digital broadcasting reception module and displays a mode selection window on the display part to select whether converting to the third power mode according to a selection through the mode selection part, and the power controller controls the power switch to make the digital broadcasting reception module convert its mode to the third power mode corresponding the selection through the mode selection window and the mode selection part.

According to an aspect of the present invention, the portable computer further comprises a mode selection part to select conversion to the second power mode or to the third power mode, wherein the power manager comprises a power controller which controls the power switch to make the digital broadcasting reception module to convert its mode from the first power mode to the second power mode if the conversion to the second power mode is selected through the mode selection part while the digital broadcasting reception module operates in the first power mode, and to convert its mode from the second power mode to the third power mode if the conversion to the third power mode is selected through the mode selection part while the digital broadcasting reception module operates in the second power mode.

According to an aspect of the present invention, the portable computer further comprises a display part to display an image thereon, wherein the power manager further comprises a reception module driver which controls driving of the digital broadcasting reception module and displays a first mode selection window on the display part to select the conversion to the second power mode or to the third power mode according to a selection through the mode selection part, and the power controller controls the power switch to make the digital broadcasting reception module convert its mode to the second power mode or to the third power mode corresponding to the selection through the first mode selection window and the mode selection part.

According to an aspect of the present invention, the power controller controls the power switch to make the digital broadcasting reception module to convert its mode from the third power mode to the second power mode if the conversion to the second mode is selected through the mode selection part while the digital broadcasting reception module operates in the third power mode, and to convert its mode from the second power mode to the first power mode if the conversion to the first power mode is selected through the mode selection part while the digital broadcasting reception module operates in the second power mode.

According to an aspect of the present invention, the reception module driver displays a second mode selection window on the display part to select the conversion to the second power mode or to the first power mode according to the selection through the mode selection part, and the power controller controls the power switch to make the digital broadcasting reception module convert its mode to the second power mode or to the first power mode corresponding to the selection through the second mode selection window and the mode selection part.

According to an aspect of the present invention, the initializing routine performer enables data interface between the power controller and the digital broadcasting reception module if the mode of the digital broadcasting reception module is converted from the first power mode to the second power mode by the power controller, and disables the data interface between the power controller and the digital broadcasting reception module if the mode of the digital broadcasting module is converted from the second power mode to the first power mode by the power controller.

The foregoing and/or other aspects of the present invention are also achieved by providing a method of controlling a portable computer having a digital broadcasting reception module comprising a digital broadcasting receiving part to receive digital multimedia broadcasting signals and a digital broadcasting processor to process the digital multimedia broadcasting signals received through the digital broadcasting receiving part, and a power supply to supply power to drive the digital broadcasting receiving part and the digital broadcasting processor, the method comprising setting the digital broadcasting reception module as a first power mode in which power supplied from the power supply to the digital broadcasting receiving part and the digital broadcasting processor is cut off, while an initializing routine is performed to the portable computer; determining whether a predetermined first conversion condition is detected; converting the mode of the digital broadcasting reception module from the first power mode to a second power mode in which power supplied from the power supply to the digital broadcasting receiving part is cut off if the first conversion condition is detected; determining whether a predetermined second conversion condition is detected; and converting the mode of the digital broadcasting reception module from the second power mode to a third power mode in which power is supplied from the power supply to the digital broadcasting receiving part and the digital broadcasting processor if the second conversion condition is detected.

According to an aspect of the present invention, the determining whether the first conversion condition is detected comprises determining whether the power supply receives power from an adaptor.

According to an aspect of the present invention, the portable computer further comprises a mode selection part which outputs a mode conversion signal to select conversion to the second power mode or to the third power mode, wherein the determining whether the first conversion condition and/or the second conversion condition is detected comprises detecting whether the mode conversion signal is output from the mode selection part.

According to an aspect of the present invention, the method further comprises determining whether a predetermined third conversion condition is detected while the digital broadcasting reception module operates in the third power mode, converting the mode of the digital broadcasting reception module from the third power mode to the second power mode if the third conversion condition is detected; determining whether a predetermined fourth conversion condition is detected while the digital broadcasting reception module operates in the second power mode; and converting the mode of the digital broadcasting reception module from the second power mode to the first power mode if the fourth conversion condition is detected.

According to an aspect of the present invention, the portable computer further comprises a mode selection part which outputs a mode conversion signal to select conversion to the second power mode or to the first power mode, and the determining whether the third conversion condition and/or the fourth conversion condition is detected comprises detecting whether the mode conversion signal is output from the mode selection part.

According to an aspect of the present invention, the method further comprises enabling an interface between the digital broadcasting reception module and the portable computer when the mode of the digital broadcasting reception module is converted to the third power mode; and disabling the interface between the digital broadcasting reception module and the portable computer when the mode of the digital broadcasting reception module is converted to the first power mode.

The foregoing and/or other aspects of the present invention are also achieved by providing a portable computer, comprising a digital broadcasting reception module having a digital broadcasting receiving part to receive digital broadcasting signals and a digital broadcasting processor to process the digital broadcasting signals received through the digital broadcasting receiving part; a power supply which supplies power to drive the digital broadcasting receiving part and the digital broadcasting processor; and a system to control the digital broadcasting signal reception module to operate in one of a power saving mode in which power supplied from the power supply is cut off, and a driving mode in which power is supplied from the power supply.

According to an aspect of the present invention, the system comprises a power switch which controls power supplied from the power supply to the digital broadcasting reception module, and a power manager which controls the power switch to make the digital broadcasting reception module operate in one of the power saving mode and the driving mode.

According to an aspect of the present invention, the power manager comprises an initializing routine performer which performs an initializing routine to the portable computer and sets whether the digital broadcasting reception module operates in the power saving mode while the initializing routine is performed, and a power controller which controls the power switch to make the digital broadcasting reception module convert its mode from the power saving mode to the driving mode according to whether the conversion condition is detected.

According to an aspect of the present invention, the power supply receives power from a battery or an adaptor and supplies power to drive the digital broadcasting reception module, and the power controller determines that the conversion condition is detected if power is supplied from the adaptor to the power supply.

According to an aspect of the present invention, the portable computer further comprises a mode selection part to select conversion to the driving mode, wherein the power controller determines that the conversion condition is detected if the conversion to the driving mode is selected through the mode selection part.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a control block diagram of a portable computer according to an embodiment of the present invention;

FIG. 2 is a control block diagram of a power control function of the portable computer shown in FIG. 1;

FIG. 3 is a detailed control block diagram of the portable computer shown in FIG. 1;

FIGS. 4A-4D illustrate examples of mode display windows of the portable computer shown in FIGS. 1-3; and

FIGS. 5 and 6 are control flowcharts of the portable computer shown in FIGS. 1-3.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

In this application, the term “portable computer” includes any apparatus which can be carried and provided with digital broadcasting reception features. The term “portable computer” includes, but is not limited to, devices, such as, for example, mobile phones, PDAs, laptops and notebooks.

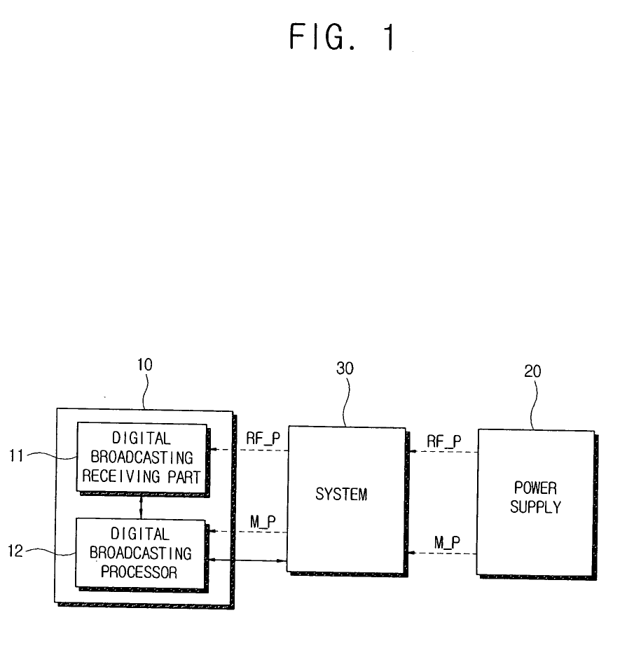

As shown in FIG. 1, a portable computer according to an embodiment of the present invention comprises a digital broadcasting reception module 10, a power supply 20 and a system 30.

The digital broadcasting reception module 10 comprises a digital broadcasting receiving part 11 to receive a digital broadcasting signal and a digital broadcasting processor 12 to process the digital broadcasting signal received through the digital broadcasting receiving part 11.

The digital broadcasting receivable by the digital broadcasting reception module includes digital multimedia broadcasting (DMB). One of digital video broadcasting (DVB) and vestigial sideband broadcasting (VSB) is used to transmit the digital broadcasting signal. Expressions of the form one of A and B may also be interpreted as A or B. The digital broadcasting may be classified as radio broadcasting and multimedia broadcasting which are complementary to each other. The digital broadcasting may comprise at least one of terrestrial digital broadcasting and satellite digital broadcasting.

The digital broadcasting receiving part 11 receives the digital broadcasting signal. The digital broadcasting receiving part 11 may comprise an antenna (not shown) to receive the digital broadcasting signal; a tuner (not shown) to change the digital broadcasting signal received through the antenna into a pass-band signal of a desired intermediate frequency; and an amplification circuit (not shown) to amplify the digital broadcasting signal.

The digital broadcasting processor 12 restores the digital broadcasting signal received from the digital broadcasting receiving part 11 into a signal recognizable by the system 30 and transmits the restored signal to the system 30. The digital broadcasting processor 12 may comprise a satellite digital broadcasting processor 12 to process a satellite digital broadcasting signal; and a digital broadcasting processor 12 to process the terrestrial digital broadcasting signal.

The power supply 20 supplies power to drive the digital broadcasting reception module 10. The power supply 20 independently supplies power to drive the digital broadcasting receiving part 11 and the digital broadcasting processor 12 of the digital broadcasting reception module 10. Hereinafter, power supplied from the power supply 20 to the digital broadcasting receiving part 11 will be referred to as receiving part driving power RF_P, and power supplied to the digital broadcasting processor 12 will be referred to as processor driving power M_P.

The system 30 receives the digital broadcasting signal received and processed by the digital broadcasting reception module 10 to output the received and processed signal as an image and/or a sound. The system 30 controls the digital broadcasting reception module 10 to operate in one of a first power mode, a second power mode and a third power mode. That is, the digital broadcasting reception module 10 may selectively operate in either the first, second or third power modes.

In the first power mode of the digital broadcasting reception module 10, the receiving part driving power RF_P and the processor driving power M_P from the power supply 20 are cut off from being supplied to the digital broadcasting receiving part 11 and the digital broadcasting processor 12, respectively. In the second power mode of the digital broadcasting reception module 10, the receiving part driving power RF_P supplied from the power supply 20 is cut off from being supplied to the digital broadcasting receiving part 11, and the processor driving power M_P alone is supplied to the digital broadcasting processor 12. In the third power mode of the digital broadcasting reception module 10, the receiving part driving power RF_P and the processor driving power M_P from the power supply 20 are supplied to the digital broadcasting receiving part 11 and the digital broadcasting processor 12.

As described above, the system 30 controls the receiving part driving power RF_P and the processor driving power M_P supplied to the digital broadcasting reception module 10 to make the digital broadcasting reception module 10 to operate in one of the first, second and third power modes, thereby controlling power consumed by the digital broadcasting reception module 10.

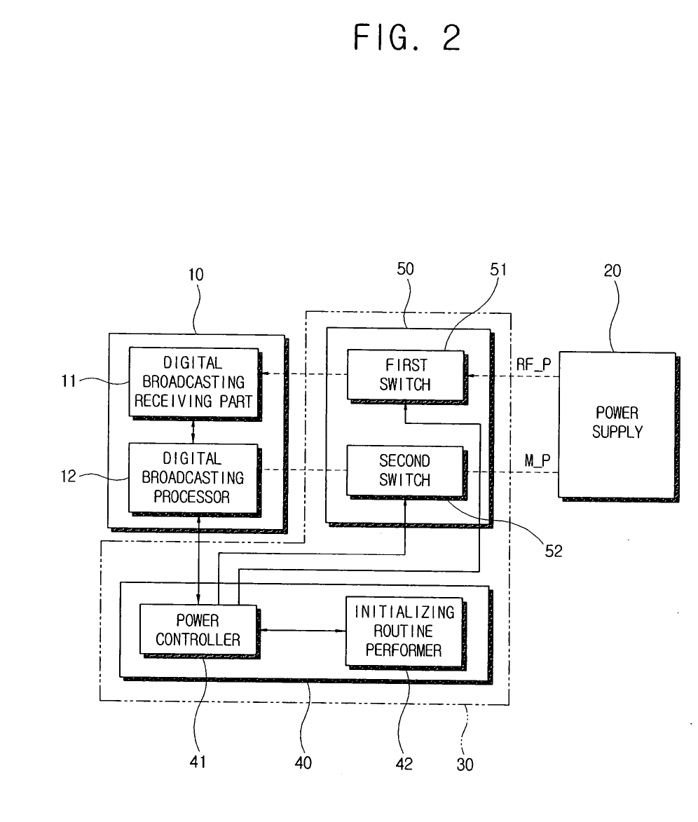

Referring to FIG. 2, the system 30 may comprise a power switch 50 and a power manager 40. The power switch 50 controls the receiving part driving power RF_P and/or the processor driving power M_P supplied from the power supply 20 to the digital broadcasting receiving part 11 and/or the digital broadcasting processor 12, according to a control of the power manager 40. The power switch 50 may comprise a first switch 51 to control the receiving part driving power RF_P supplied to the digital broadcasting receiving part 11; and a second switch 52 to control the processor driving power M_P supplied to the digital broadcasting processor 12.

The power manager 40 controls the first switch 51 and the second switch 52 of the power switch 50 to make the digital broadcasting reception module 10 operate in one of the first power mode, the second power mode and the third power mode.

The power manager 40 may comprise a power controller 41 to control switching operation of the first switch 51 and the second switch 52; and an initializing routine performer 42.

The initializing routine performer 42 performs an initializing routine of the respective elements of the system 30 and the digital broadcasting reception module 10 of the portable computer when the portable computer is turned on. The initializing routine performer 42 may comprise a basic input output system (BIOS) program to perform the initializing routine of the portable computer, or may comprise other programs to perform the initializing routine of the portable computer, regardless of their names.

Further, the initializing routine performer 42 may set whether the digital broadcasting reception module 10 operates in the first power mode while the initializing routine is performed. For example, if the initializing routine performer 42 is provided as the BIOS program, a user may set whether the digital broadcasting reception module 10 operates in the first power mode, in a BIOS setup state when initially booting the portable computer.

Thus, the portable computer may set whether the digital broadcasting reception module 10 receives the receiving part driving power RF_P and the processor driving power M_P when initially booting. If a user does not use the digital broadcasting reception module 10, the user may set the digital broadcasting reception module 10 to operate in the first power mode, at the BIOS setup stage, thereby preventing power consumption of the digital broadcasting reception module 10. If the user uses the digital broadcasting reception module 10, the user may release the setting of the first power mode of the digital broadcasting reception module 10 at the BIOS setup stage.

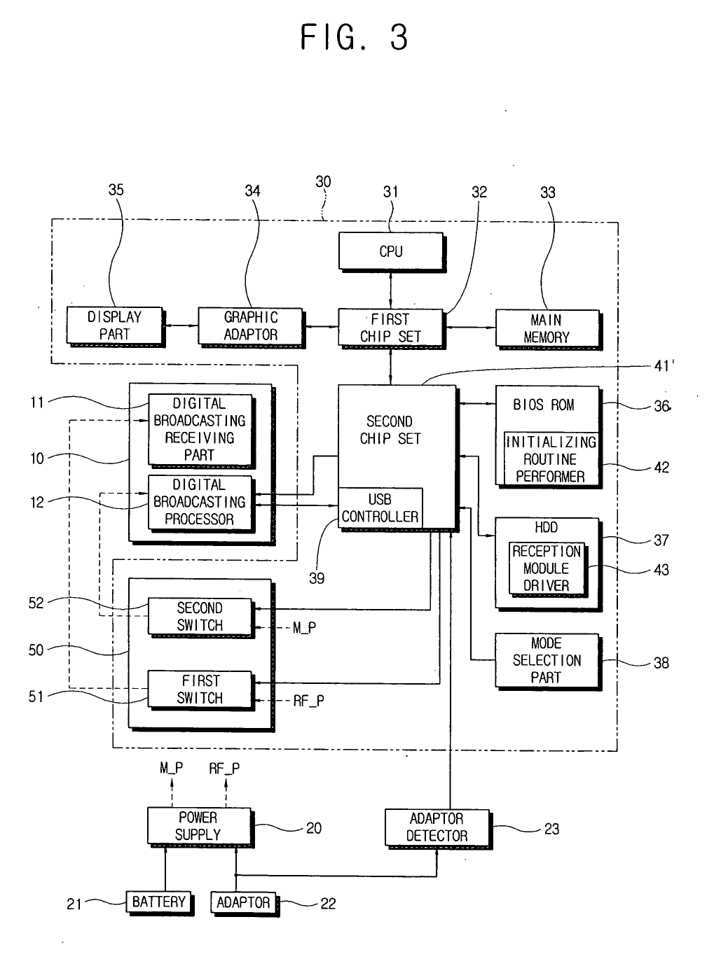

The portable computer according to the embodiment of the present invention will be described in detail with reference to FIG. 3. The system 30 may comprise a central processing unit (CPU) 31, a main memory 33, a graphic adaptor 34 which is connected to a display part 35 to transmit a video signal to the display part 35, a first chipset 32 and a second chipset 41′. The system 30 may comprise a BIOS ROM 36 and a hard disc drive 37 which exchange data through the second chipset 41′. The main memory 33 may be provided as a random access memory (RAM) which is a volatile memory.

The first chip set 32 manages data which travels between the CPU 31, the main memory 33 and the graphic adaptor 34. The first chip set 32 may be provided as a memory control hub or a north bridge. The first chip set 32 may be provided as a graphic memory control hub (GMCH) which is integrally provided with the graphic adaptor 34.

The second chip set 41′ manages data which travels between the digital broadcasting reception module 10, the BIOS ROM 36, and the hard disc drive 37. The second chip set 41′ manages data which travels between various input and output devices connected to the portable computer or installed therein. The second chip set 41′ may be provided as an input/output control hub (ICH) or a south bridge.

A data interface between the second chip set 41′ and the digital broadcasting reception module 10 may comprise a universal serial bus (USB) interface which supports plug & play. Thus, a USB controller 39 may be mounted in the second chip set 41′ to manage data exchanged by the USB interface with the digital broadcasting reception module 10. Also, the USB controller 39 may be provided as an additional chip set distinguishable from the second chip set 41′.

The second chip set 41′ may function as the power controller 41 in FIG. 2 which controls the switching operation of the power switch 50. The initializing routine performer 42 in FIG. 2 is stored in the BIOS ROM 36.

The second chip set 41′ controls the power switch 50 to make the digital broadcasting reception module 10 operate in one of the first power mode, the second power mode and the third power mode according to whether a first conversion condition, a second conversion condition, a third conversion condition and a fourth conversion condition, which are preset, are detected.

The first conversion condition is a condition to make the digital broadcasting reception module 10 convert from the first power mode to the second power mode. The second conversion condition is a condition to make the digital broadcasting reception module 10 convert from the second power mode to the third power mode. The third conversion condition is a condition to make the digital broadcasting reception module 10 convert from the third power mode to the second power mode. The fourth conversion condition is a condition to make the digital broadcasting reception module 10 to convert from the second power mode to the first power mode.

If the first conversion condition is detected while the digital broadcasting reception module 10 operates in the first power mode, the second chip set 41′ turns on the second switch 52 to supply the processor driving power M_P from the power supply 20 to the digital broadcasting processor 12, and converts the mode of the digital broadcasting reception module 10 from the first power mode to the second power mode.

The second chip set 41′ may recognize a detection of power being supplied from an adaptor 22 to the power supply 20 as the detection of the first conversion condition. That is, if detected that power from the adaptor 22 is supplied to the power supply 20 in a state that the digital broadcasting reception module 10 operates in the first power mode and power is supplied from the battery 21 to the power supply 20, the second chip set 41′ converts the mode of the digital broadcasting reception module 10 from the first power mode to the second power mode.

The portable computer may further comprise an adaptor detector 23 to detect whether power is supplied from the adaptor 22 to the power supply 20. A detection result of the adaptor detector 23 is supplied to the second chip set 41′, and the second chip set 41′ determines whether the first conversion condition is detected, according to the detection result of the adaptor detector 23.

The initializing routine performer 42 may enable the USB controller 39 to manage the data interface between the second chip set 41′ and the digital broadcasting reception module 10 if detected that the mode of the digital broadcasting reception module 10 is changed from the first power mode to the second power mode by the second chip set 41′. Accordingly, the second chip set 41′ and the digital broadcasting reception module 10 may communicate data with each other.

If the second conversion condition is detected while the digital broadcasting reception module 10 operates in the second power mode, the second chip set 41′ controls the power switch 50 to convert the mode of the digital broadcasting reception module 10 from the second power mode to the third power mode. If the third conversion condition is detected while the digital broadcasting reception module 10 operates in the third power mode, the second chip set 41′ controls the power switch 50 to convert the mode of the digital broadcasting reception module 10 from the third power mode to the second power mode. If the fourth conversion condition is detected while the digital broadcasting reception module 10 operates in the second power mode, the second chip set 41′ controls the power switch 50 to convert the mode of the digital broadcasting reception module 10 from the second power mode to the first power mode.

If a user converts the digital broadcasting reception module 10 to the third power mode, the second power mode or to the first power mode through a mode selection part 38 while the digital broadcasting reception module 10 operates in the second or third power mode, the second chip set 41′ may recognize that the second conversion condition, the third conversion condition or the fourth conversion condition is detected.

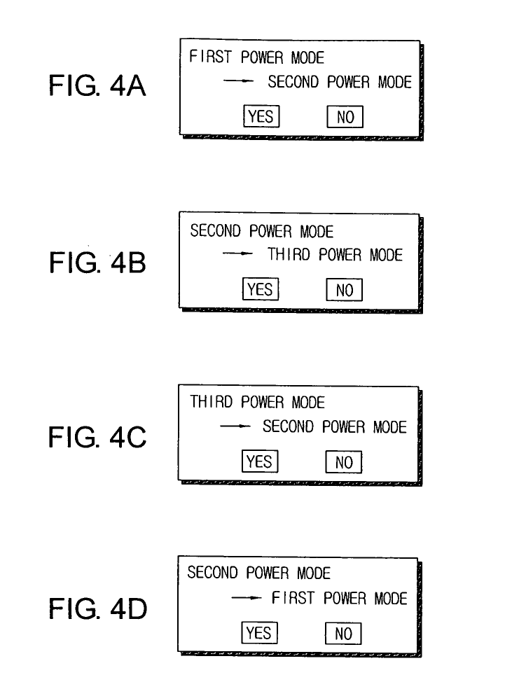

A reception module driver 43 may display a mode selection window on the display part 35 to convert the mode of the digital broadcasting reception module 10 to the third power mode, the second power mode or the first power mode if the user controls the mode selection part 38. FIG. 4A illustrates an example of the mode selection window to convert the mode of the digital broadcasting reception module 10 from the first power mode to the second power mode. FIG. 4B illustrates an example of the mode selection window to convert the mode of the digital broadcasting reception module 10 from the second power mode to the third power mode. FIG. 4C illustrates an example of the mode selection window to convert the mode of the digital broadcasting reception module 10 from the third power mode to the second power mode. FIG. 4D illustrates an example of the mode selection window to convert the mode of the digital broadcasting reception module 10 from the second power mode to the first power mode.

If the second conversion condition is detected, the second chip set 41′ turns on the first switch 51 to supply the receiving part driving power RF_P from the power supply 20 to the digital broadcasting receiving part 11, and converts the mode of the digital broadcasting reception module 10 from the second power mode to the third power mode.

If the third conversion condition is detected, the second chip set 41′ turns off the first switch 51 to cut off the receiving part driving power RF_P from the power supply 20 to the digital broadcasting receiving part 11, and converts the mode of the digital broadcasting reception module 10 from the third power mode to the second power mode.

If the fourth conversion condition is detected, the second chip set 41′ turns off the second switch 52 to cut off the receiving part driving power RF_P from the power supply 20 to the digital broadcasting receiving part 11, and converts the mode of the digital broadcasting reception module 10 from the second power mode to the first power mode. At this time, the initializing routine performer 42 may disable the USB controller 39 which manages the data interface between the second chip set 41′ and the digital broadcasting reception module 10, if detected that the mode of the digital broadcasting reception module 10 is converted from the second power mode to the first power mode by the second chip set 41′.

In the foregoing embodiment, the second chip set 41′ recognizes whether the first conversion condition is detected, according to power supply from the adaptor 22. Also, the second chip set 41′ may recognize that the first conversion condition is detected if the user converts the mode of the digital broadcasting reception module 10 to the second power mode through the mode selection part 38 in a state that the digital broadcasting reception module 10 operates in the first power mode.

If the user selects the conversion to the second power mode through the mode selection part 38, the reception module driver 43 may display the mode selection window (refer FIG. 4A) on the display part 35 to select conversion to the second power mode. Then, the user may select the mode selection window to be displayed through the mode selection part 38 while the digital reception module 10 operates in the first power mode, and may select the conversion to the second power mode through the mode selection part 38 by using the mode selection window displayed on the display part 35 by the reception module driver 43.

In the foregoing embodiment, if detected that power is supplied from the adaptor 22, the second chip set 41′ converts the mode of the digital broadcasting reception module 10 from the first power mode to the second power mode. Also, if detected that power is supplied from the adaptor 22, the second chip set 41′ may inform the reception module driver 43 that power is supplied from the adaptor 22. If the reception module driver 43 is informed of the detection of power being supplied from the second chip set 41′, the reception module driver 43 may display the mode selection window (refer to FIG. 4A) on the display part 35 to select conversion to the second power mode. The second chip set 41′ converts the mode of the digital broadcasting reception module 10 from the first power mode to the second power mode only when the user selects the conversion to the second power mode through the mode selection window.

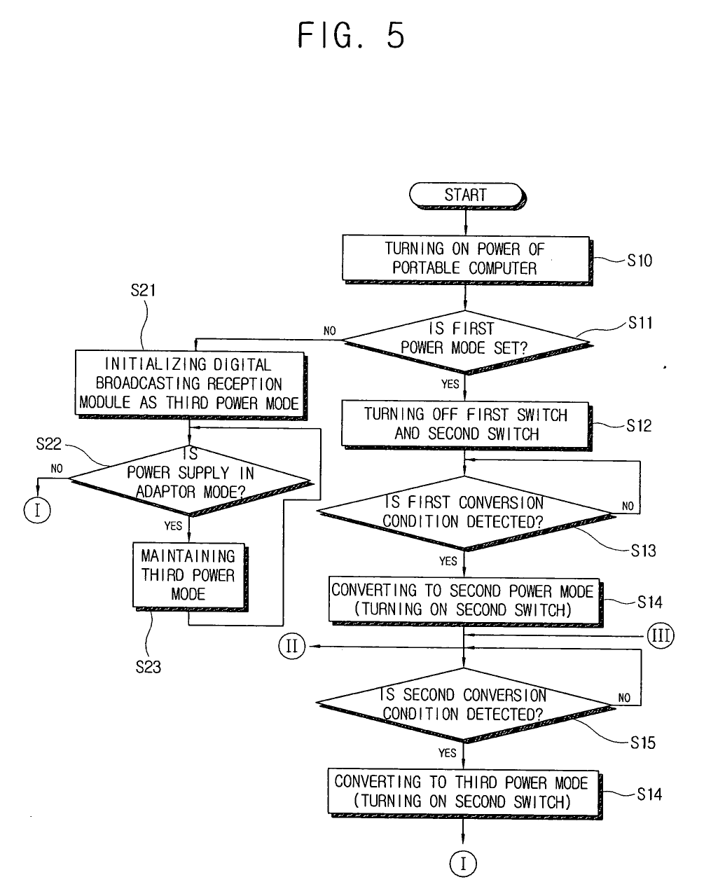

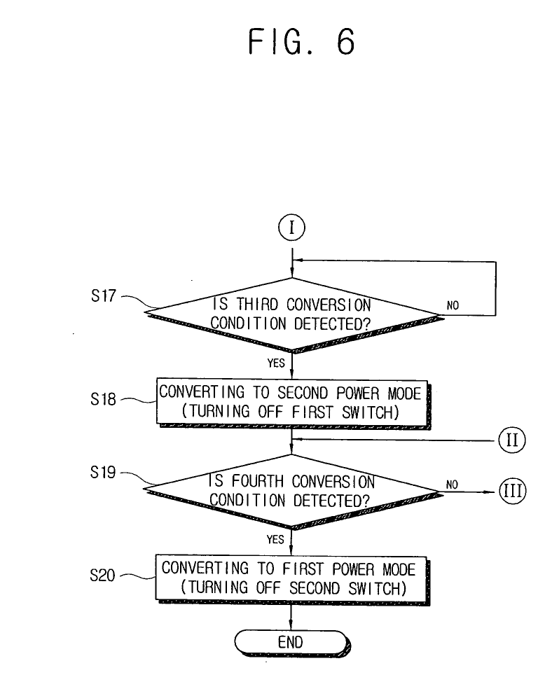

A method of controlling the portable computer according to an embodiment of the present invention will be described with reference to FIGS. 5 and 6. The symbols I, II and III shown in FIGS. 5 and 6 indicate interconnections between operations shown in FIGS. 5 and 6.

First, if a user turns on power of the portable computer at operation S10, the initializing routine performer 42 performs the initializing routine of the system 30 and the digital broadcasting reception module 10. At this time, the initializing routine performer 42 checks whether the digital broadcasting reception module 10 is set as the first power mode at operation S11, and informs the second chip set 41′ if the digital broadcasting reception module 10 is set as the first power mode. Accordingly, the second chip set 41′ turns off the first switch 51 and the second switch 52 at operation S12, and controls the digital broadcasting reception module 10 to be in the first power mode.

If the first conversion condition is detected at operation S13 while the digital broadcasting reception module 10 operates in the first power mode, the second chip set 41′ turns on the second switch 52 to convert the mode of the digital broadcasting reception module 10 to the second power mode at operation S14. At this time, the second chip set 41′ informs the detection of the first conversion condition to the initializing routine performer 42. The initializing routine performer 42 may enable the data interface between the digital broadcasting reception module 10 and the second chip set 41′.

Then, the second chip set 41′ determines whether the second conversion condition is detected while the digital broadcasting reception module 10 operates in the second power mode, at operation S15. Also, the second chip set 41′ may determine whether the fourth conversion condition is detected while the digital broadcasting reception module 10 operates in the second power mode, at operation S19.

The second chip set 41′ turns on the first switch 51 to convert the mode of the digital broadcasting reception module 10 from the second power mode to the third power mode if the second conversion condition is detected while the digital broadcasting reception module 10 operates in the second power mode, at operation S16.

The second chip set 41′ turns on the second switch 51 to convert the mode of the digital broadcasting reception module 10 from the second power mode to the first power mode if the fourth conversion condition is detected while the digital broadcasting reception module 10 operates in the second power mode, at operation S20.

The second chip set 41′ determines whether the third conversion condition is detected while the digital broadcasting reception module 10 operates in the third power mode, at operation S1 7. The second chip set 41′ turns off the first switch 51 to convert the mode of the digital broadcasting reception module 10 from the third power mode to the second power mode if the third conversion condition is detected, at operation S18.

Returning to operation S11, if the first power mode is not set while the initializing routine of the portable computer is performed by the initializing routine performer 42, the initializing routine performer 42 informs the second chip set 41′. Then, the second chip set 41′ turns on the first switch 51 and the second switch 52 to make the digital broadcasting reception module 10 operate in the third power mode, at operation S21.

When the digital broadcasting reception module 10 is initialized to the third power mode at operation S21, the second chip set 41′ determines whether the power supply 20 operates in an adaptor mode in which power is supplied from the adaptor 22, at operation S22. If the power supply 20 operates in the adaptor mode, the second chip set 41′ controls the digital broadcasting reception module 10 remain in the third power mode at operation S23. Conversely, if the power supply 20 does not operate in the adaptor mode, i.e., if power is supplied from the battery 21 to the power supply 20, the second chip set 41′ performs operations S17 through S20 according to whether the third conversion condition is detected.

In the foregoing embodiment, the digital broadcasting reception module 10 of the portable computer operates in one of the first power mode, the second power mode and the third power mode. Also, the digital broadcasting reception module 10 of the portable computer according to the embodiment of the present invention may operate in one of the first power mode (which may also be referred to as a power saving mode) and the third power mode (which may also be referred to as a driving mode), omitting the second power mode.

The setting of the power saving mode corresponds to the setting of the first power mode. A conversion process from the power saving mode to the driving mode corresponds to the conversion process from the first power mode to the second power mode. Also, the conversion process from the driving mode to the power saving mode corresponds to the conversion process from the second power mode to the first power mode.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A portable computer, comprising:
a digital broadcasting reception module having a digital broadcasting receiving part to receive digital broadcasting signals and a digital broadcasting processor to process the digital broadcasting signals received through the digital broadcasting receiving part;
a power supply to supply power to drive the digital broadcasting receiving part and the digital broadcasting processor; and
a system to control the digital broadcasting signal reception module to operate in one of a first power mode in which power supplied from the power supply to the digital broadcasting receiving part and the digital broadcasting signal processor is cut off, a second power mode in which power supplied from the power supply to the digital broadcasting receiving part is cut off, and a third power mode in which power is supplied from the power supply to the digital broadcasting receiving part and the digital broadcasting processor.

2. The portable computer according to claim 1, wherein the system comprises:
a power switch which switches the power supplied from the power supply to the digital broadcasting receiving part and/or the digital broadcasting processor, and
a power manager which controls the power switch to make the digital broadcasting reception module operate in one of the first power mode, the second power mode and the third power mode.

3. The portable computer according to claim 2, wherein:
the power manager comprises an initializing routine performer which performs an initial routine to the portable computer and sets whether the digital broadcasting reception module operates in the first power mode while the initial routine is performed.

4. The portable computer according to claim 3, wherein:
the power supply receives power from a battery or an adaptor and supplies the power to drive the digital broadcasting reception module, and
the power manager comprises a power controller which controls the power switch to convert the mode of the digital broadcasting reception module from the first power mode to the second power mode if detected that the power supply receives power from the adaptor.

5. The portable computer according to claim 4, further comprising:
a mode selection part which selects whether the mode of the digital broadcasting reception module is converted into the third power mode, wherein:
the power controller controls the power switch to make the digital broadcasting reception module convert from the second power mode to the third power mode if the conversion to the third power mode is selected through the mode selection part.

6. The portable computer according to claim 5, further comprising:
a display part to display an image thereon, wherein:
the power manager further comprises a reception module driver which controls driving of the digital broadcasting reception module and displays a mode selection window on the display part to select whether to convert to the third power mode according to a selection through the mode selection part, and
the power controller controls the power switch to make the digital broadcasting reception module convert to the third power mode if the selection to convert is made through the mode selection window and the mode selection part.

7. The portable computer according to claim 3, further comprising:
a mode selection part to select conversion to the second power mode or to the third power mode, wherein:
the power manager comprises a power controller which controls the power switch to make the digital broadcasting reception module to convert from the first power mode to the second power mode if the conversion to the second power mode is selected through the mode selection part while the digital broadcasting reception module operates in the first power mode, and to convert from the second power mode to the third power mode if the conversion to the third power mode is selected through the mode selection part while the digital broadcasting reception module operates in the second power mode.

8. The portable computer according to claim 7, further comprising:
a display part to display an image thereon, wherein:
the power manager further comprises a reception module driver which controls driving of the digital broadcasting reception module and displays a first mode selection window on the display part to select the conversion to the second power mode or to the third power mode according to a selection through the mode selection part, and
the power controller controls the power switch to make the digital broadcasting reception module convert to the second power mode or to the third power mode corresponding to the selection through the first mode selection window and the mode selection part.

9. The portable computer according to claim 8, wherein:
the power controller controls the power switch to make the digital broadcasting reception module to convert from the third power mode to the second power mode if the conversion to the second mode is selected through the mode selection part while the digital broadcasting reception module operates in the third power mode, and to convert from the second power mode to the first power mode if the conversion to the first power mode is selected through the mode selection part while the digital broadcasting reception module operates in the second power mode.

10. The portable computer according to claim 9, wherein:
the reception module driver displays a second mode selection window on the display part to select the conversion to the second power mode or to the first power mode according to the selection through the mode selection part, and
the power controller controls the power switch to make the digital broadcasting reception module convert to the second power mode or to the first power mode corresponding to the selection through the second mode selection window and the mode selection part.

11. The portable computer according to claim 3, wherein the initializing routine performer enables data interface between the power controller and the digital broadcasting reception module if the mode of the digital broadcasting reception module is converted from the first power mode to the second power mode by the power controller, and disables the data interface between the power controller and the digital broadcasting reception module if the mode of the digital broadcasting module is converted from the second power mode to the first power mode by the power controller.

12. The portable computer according to claim 6, wherein the power controller controls the power switch to make the digital broadcasting reception module to convert from the third power mode to the second power mode if the conversion to the second mode is selected through the mode selection part while the digital broadcasting reception module operates in the third power mode, and to convert from the second power mode to the first power mode if the conversion to the first power mode is selected through the mode selection part while the digital broadcasting reception module operates in the second power mode.

13. The portable computer according to claim 12, wherein:
the reception module driver displays a second mode selection window on the display part to select the conversion to the second power mode or to the first power mode according to the selection through the mode selection part, and
the power controller controls the power switch to make the digital broadcasting reception module convert to the second power mode or to the first power mode corresponding to the selection through the second mode selection window and the mode selection part.

14. A method of controlling a portable computer having a digital broadcasting reception module comprising a digital broadcasting receiving part to receive digital multimedia broadcasting signals and a digital broadcasting processor to process the digital multimedia broadcasting signals received through the digital broadcasting receiving part, and a power supply to supply power to drive the digital broadcasting receiving part and the digital broadcasting processor, the method comprising:
setting the digital broadcasting reception module as a first power mode in which power supplied from the power supply to the digital broadcasting receiving part and the digital broadcasting processor is cut off, while performing an initializing routine to the portable computer;
determining whether a predetermined first conversion condition is detected;
converting the mode of the digital broadcasting reception module from the first power mode to a second power mode in which the power supplied from the power supply to the digital broadcasting receiving part is cut off if the first conversion condition is detected;
determining whether a predetermined second conversion condition is detected; and
converting the mode of the digital broadcasting reception module from the second power mode to a third power mode in which the power is supplied from the power supply to the digital broadcasting receiving part and the digital broadcasting processor if the second conversion condition is detected.

15. The method according to claim 14, wherein the determining of whether the first conversion condition is detected comprises determining whether the power supply receives power from an adaptor.

16. The method according to claim 14, further comprising:
generating a mode conversion signal to select conversion to the second power mode or to the third power mode, wherein:
the determining whether the first conversion condition or the second conversion condition is detected comprises detecting whether the mode conversion signal is output from the mode selection part.

17. The method according to claim 14, further comprising:
determining whether a predetermined third conversion condition is detected while the digital broadcasting reception module operates in the third power mode,
converting the mode of the digital broadcasting reception module from the third power mode to the second power mode if the third conversion condition is detected;
determining whether a predetermined fourth conversion condition is detected while the digital broadcasting reception module operates in the second power mode; and
converting the mode of the digital broadcasting reception module from the second power mode to the first power mode if the fourth conversion condition is detected.

18. The method according to claim 17, further comprising:
generating a mode conversion signal to select conversion to the second power mode or to the first power mode, wherein:
the determining of whether the third conversion condition or the fourth conversion condition is detected comprises detecting whether the mode conversion signal is output from the mode selection part.

19. The method according to claim 17, further comprising:
enabling an interface between the digital broadcasting reception module and other portions of the portable computer when the mode of the digital broadcasting reception module is converted to the third power mode; and
disabling the interface between the digital broadcasting reception module and the other portions of the portable computer when the mode of the digital broadcasting reception module is converted to the first power mode.

20. A portable computer, comprising:
a digital broadcasting reception module having a digital broadcasting receiving part to receive digital broadcasting signals and a digital broadcasting processor to process the digital broadcasting signals received through the digital broadcasting receiving part;
a power supply which supplies power to drive the digital broadcasting receiving part and the digital broadcasting processor; and
a system to control the digital broadcasting signal reception module to operate in one of a power saving mode in which the power supplied from the power supply is cut off, and a driving mode in which the power is supplied from the power supply.

21. The portable computer according to claim 20, wherein the system comprises a power switch which controls the power supplied from the power supply to the digital broadcasting reception module, and a power manager which controls the power switch to make the digital broadcasting reception module operate in one of the power saving mode and the driving mode.

22. The portable computer according to claim 21, wherein the power manager comprises:
an initializing routine performer which performs an initializing routine to the portable computer and sets whether the digital broadcasting reception module operates in the power saving mode while the initializing routine is performed, and
a power controller which controls the power switch to make the digital broadcasting reception module convert from the power saving mode to the driving mode according to whether the conversion condition is detected.

23. The portable computer according to claim 22, wherein:
the power supply receives the power from a battery or an adaptor and supplies the power to drive the digital broadcasting reception module, and
the power controller determines that the conversion condition is detected if the power is supplied from the adaptor to the power supply.

24. The portable computer according to claim 23, further comprising:
a mode selection part to select conversion to the driving mode, wherein:
the power controller determines that the conversion condition is detected if the conversion to the driving mode is selected through the mode selection part.

25. The portable computer according to claim 23, further comprising:
an adaptor detector to detect whether the power is supplied from the adaptor to the power supply.

26. A portable computer, comprising:
a digital broadcasting receiver to receive digital broadcasting signals;
a digital broadcasting processor to process the digital broadcasting signals;
a power supply supplying power to drive the digital broadcasting receiver and the digital broadcasting processor, the power supply operable from a battery or an adaptor; and
a controller controlling the drive power to the digital broadcasting receiver and the digital broadcasting processor; and
a user programmable initializing routine performer which determines whether the controller initially supplies the power to the digital broadcasting receiver and the digital broadcast processor during a boot-up operation of the portable computer.

27. The portable computer of claim 26, wherein:
where the user programmable initializing routine performer determines the controller to initially supply the power to the digital broadcasting receiver and the digital broadcast processor during the boot-up operation and the power is not being supplied by the adaptor, the controller turns off the power to the digital broadcast receiver.

28. The portable computer of claim 26, wherein:
where the user programmable initializing routine performer determines the controller not to initially supply the power to the digital broadcasting receiver and the digital broadcast processor during the boot-up operation and the power is being supplied by the adaptor, the controller maintains power off to the digital broadcasting receiver and the digital broadcast processor.

29. The portable computer of claim 26, further comprising:
a selector operable by a user, wherein:
where the user programmable initializing routine performer determines the controller to initially supply the power to the digital broadcasting receiver and the digital broadcast processor during the boot-up operation, and power being supplied by the adaptor is removed after the boot-up operation, the controller requests the user to select whether to continue supplying the power to the one or both of the digital broadcasting receiver and the digital broadcasting processor using the user operable selector.

30. The portable computer of claim 26, further comprising:
a selector operable by a user and permitting the user to selectively control the supply of power to the digital broadcasting receiver and the digital broadcast processor independently of the supply of power determined by the user programmable initializing routine performer.

31. The portable computer of claim 27, further comprising:
a selector operable by a user and permitting the user to selectively control the supply of power to the digital broadcasting receiver and the digital broadcast processor independently of the supply of power determined by the user programmable initializing routine performer.

32. The portable computer of claim 28, further comprising:
a selector operable by a user and permitting the user to selectively control the supply of power to the digital broadcasting receiver and the digital broadcast processor independently of the supply of power determined by the user programmable initializing routine performer.

33. A portable computer, comprising:
a port through which a digital broadcasting module may be removably connected, the digital broadcasting module comprising a digital broadcasting receiver and a digital broadcasting processor to process the digital broadcasting signals;
a power supply supplying power from a battery or from an adaptor; and
a controller controlling the power supplied to the port to selectively drive at least one of the digital broadcasting receiver and the digital broadcasting processor, wherein the controller determines whether the power is initially supplied to the port during a boot-up operation of the portable computer based on a user selectable preference, whether the digital broadcasting module is connected to the port, and whether the power is being supplied to the port from the battery or from the adaptor.
